(19) United States
(12) Patent Application Publication
(10) Pub. No.: US 2023/0236600 A1
(43) Pub. Date: Jul. 27, 2023

(54) Operational State Detection for Obstacles in Mobile Robots

(71) Applicant: ZEBRA TECHNOLOGIES CORPORATION, Lincolnshire, IL (US)

(72) Inventors: Peter Arandorenko, Mississauga (CA); Asma Azim, Brampton (CA); Achal Arvind, Santa Clara, CA (US); Jenna Stephanie Guergah, Santa Cruz, CA (US); Aoran Jiao, Mississauga (CA)

(21) Appl. No.: 17/971,359

(22) Filed: Oct. 21, 2022

(30) Foreign Application Priority Data
Jan. 24, 2022 (JP) 2022-008627

(51) Int. Cl. G05D 1/02; G06V 40/10; G06V 20/58

(52) U.S. Cl. CPC G05D 1/0214; G06V 40/10; G06V 20/58; G06V 10/764

(57) ABSTRACT

A method includes: capturing, using a sensor of a mobile robot, sensor data representing a physical environment of the mobile robot; detecting, from the sensor data, an obstacle in the physical environment; responsive to detecting the obstacle, determining from the sensor data whether the obstacle exhibits a predetermined attribute; assigning a first operational state or a second operational state to the obstacle, according to the determination; selecting a navigational constraint based on the assigned operational state; and controlling a locomotive assembly of the mobile robot to navigate the physical environment based on the selected navigational constraint.

### BACKGROUND

Autonomous or semi-autonomous mobile robots can be deployed in facilities such as warehouses, manufacturing facilities, healthcare facilities, or the like, e.g., to transport items within the relevant facility. To navigate a facility, a mobile robot captures sensor data (e.g., images, or the like) and detects obstacles within the sensor data. The mobile robot may then generate a path, e.g., towards a target location, taking into account any detected obstacles. A wide variety of obstacles may be present in the facility, including stationary obstacles and moving obstacles.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an item-handing mobile robot deployed in a facility.

FIG. 2 is a diagram of certain components of a mobile robot of FIG. 1.

FIG. 3 is a flowchart illustrating a method of operational state detection for obstacles.

FIG. 4 is a diagram illustrating an example performance of block 305 of the method of FIG. 3.

FIG. 5 is a diagram illustrating an example performance of block 310 of the method of FIG. 3.

FIG. 6 is a diagram illustrating an example performance of blocks 320 and 325 of the method of FIG. 3.

FIG. 7 is a diagram illustrating another example performance of blocks 320, 325, and 330 of the method of FIG. 3.

FIG. 8 is a diagram illustrating an example performance of block 345 of the method of FIG. 3.

FIG. 9 is a diagram illustrating another example performance of block 345 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In an embodiment, to optimize navigation around an obstacle, a robot identifies whether the obstacle is in a moving or stationary state and implements a corresponding navigational approach.

Examples disclosed herein are directed to a method, comprising: capturing, using a sensor of a mobile robot, sensor data representing a physical environment of the mobile robot; detecting, from the sensor data, an obstacle in the physical environment; responsive to detecting the obstacle, determining from the sensor data whether the obstacle exhibits a predetermined attribute; assigning an operational state to the obstacle, according to the determination; selecting a navigational constraint based on the assigned operational state; and controlling a locomotive assembly of the mobile robot to navigate the physical environment based on the selected navigational constraint.

Additional examples disclosed herein are directed to a computing device, comprising: a sensor; and a processor configured to: capture, using the sensor, sensor data representing a physical environment of a mobile robot; detect, from the sensor data, an obstacle in the physical environment; responsive to detecting the obstacle, determine from the sensor data whether the obstacle exhibits a predetermined attribute; assign an operational state to the obstacle, according to the determination; select a navigational constraint based on the assigned operational state; and control a locomotive assembly of the mobile robot to navigate the physical environment based on the selected navigational constraint.

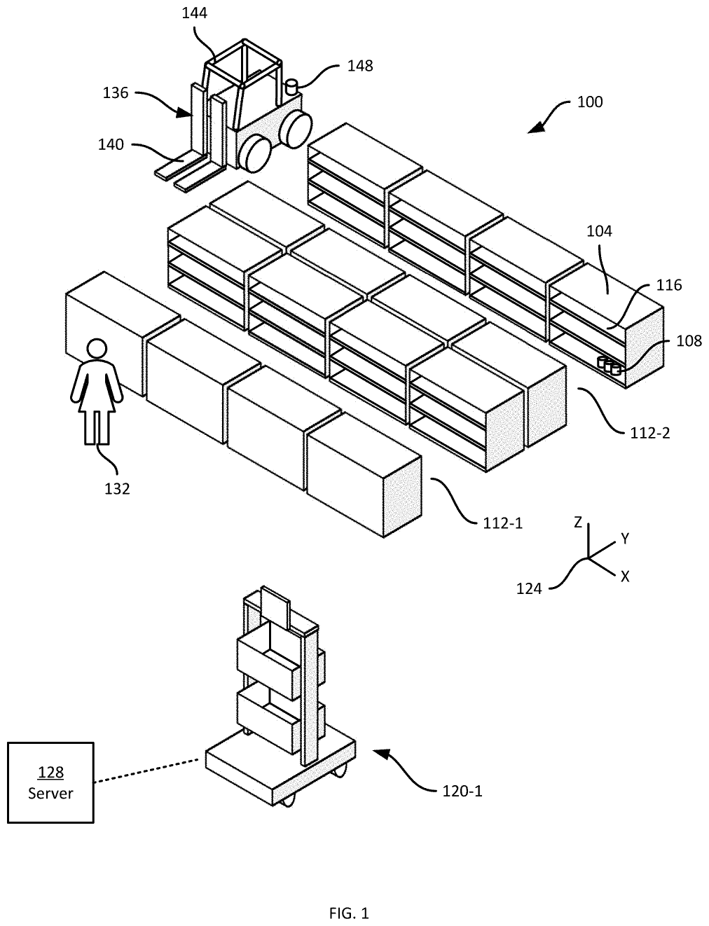

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components). As shown in FIG. 1, support structures 104 in the form of shelf modules include support surfaces 116 supporting the items 108. The support structures 104 can also include pegboards, bins, or the like, in other examples.

In other examples, the facility 100 can include fewer aisles 112 than shown, or more aisles 112 than shown in FIG. 1. The aisle 112, in the illustrated example, are formed by sets of eight support structures 104 (four on each side). The facility can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility 100. In some examples, the facility 100 is a shipping facility, distribution facility, or the like, and the items 108 can be placed on the support structures 104 for storage, and subsequently retrieved for shipping from the facility. Placement and/or retrieval of the items 108 to and/or from the support structures can be performed or assisted by a mobile robot 120. A greater number of robots 120 can be deployed in the facility 100 than the robot 120 shown in FIG. 1, for example based on the size and/or layout of the facility 100. Components of the robot 120 are discussed below in greater detail. In general, each robot 120 in the facility 100 is configured to transport items 108 within the facility 100.

The robot 120 can be configured to track its pose (e.g., location and orientation) within the facility 100, e.g., in a coordinate system 124 previously established in the facility 100. The robot 120 can navigate autonomously within the facility 100, e.g., travelling to locations assigned to the robot 120 to receive and/or deposit items 108. The items 108 can be deposited into or onto the robot 120, and removed from the robot 120, by human workers and/or mechanized equipment such as robotic arms and the like deployed in the facility 100. The locations to which each robot 120 navigates can be assigned to the robot 120 by a central server 128. That is, the server 128 is configured to assign tasks to the robot 120. Each task can include either or both of one or more locations to travel to, and one or more actions to perform at those locations. For example, the server 128 can assign a task to the robot 120 to travel to a location defined in the coordinate system 124, and to await the receipt of one or more items 108 at that location.

Tasks can be assigned to the robots via the exchange of messages between the server 128 and the robots 120, e.g., over a suitable combination of local and wide-area networks. The server 128 can be deployed at the facility 100, or remotely from the facility 100. In some examples, the server 128 is configured to assign tasks to robots 120 at multiple facilities, and need not be physically located in any of the individual facilities.

To navigate to a given location in the facility 100 (e.g., a target location assigned to the mobile robot 120 by the server 128), the mobile robot 120 can be configured to capture sensor data representing at least a portion of the physical environment of the robot 120 (i.e., the surroundings of the robot 120). The robot 120 can then be configured to detect obstacles in its vicinity from the sensor data, and navigate around or away from the obstacles as needed.

As will be apparent to those skilled in the art, the facility 100 can contain a wide variety of obstacles. For example, as seen in FIG. 1, obstacles that the mobile robot 120 may need to navigate around include the support structures 104, humans such as a worker 132, and mobile equipment such as a forklift 136, having a chassis supporting a movable component such as a set of tines or blades 140, an operator cab 144, and an indicator light, or beacon, 148 configured to illuminate when the forklift 136 is powered on. Obstacles can also include other mobile robots, boxes, pallets, and the like. The mobile robot 120 can be configured to employ different navigational constraints when navigating in the vicinity of different obstacles. For example, when navigating along a static (i.e., stationary) obstacle such as a support structure 104, the mobile robot 120 may plan a navigational path that comes within a certain threshold distance (e.g., 10 centimeters) and travel such a path at a certain maximum velocity (e.g., 2 meters per second). When navigating in the vicinity of an obstacle in motion, such as the worker 132, the robot 120 may plan a navigational path that maintains a greater distance (e.g. two meters) from the worker 132, and travel at a lower maximum velocity (e.g., 1 meter per second).

The use of different navigational constraints for different obstacles may reflect, for example, increased uncertainty in future movements of obstacles in motion. For example, the mobile robot 120 can be configured to categorize every detected obstacle as either static (i.e., stationary) or dynamic (i.e., in motion), and to apply a distinct set of navigational constraints to each category. Certain obstacles, however, such as the forklift 136, may be stationary when initially observed by the mobile robot 120, and may therefore be categorized as static, but may move shortly thereafter, sometimes necessitating evasive action by either or both of the mobile robot 120 and an operator of the forklift 136 (e.g., the worker 132) to avoid a collision.

The mobile robot 120 is therefore configured, as discussed in detail below, not only to detect obstacles and determine the types of such obstacles (e.g., to distinguish the worker 132, the forklift 136, and the support structures 104), but also to assign operational states to certain obstacles. An operational state, e.g., in the case of the forklift 136, indicates whether the forklift is currently being operated, e.g., by the worker 132, irrespective of whether the forklift 136 is in motion. The mobile robot 120 can use the assigned operational states to select optimized navigational constraints, e.g., treating the forklift 136 as a dynamic obstacle even when the forklift 136 is not in motion when observed by the mobile robot 120.

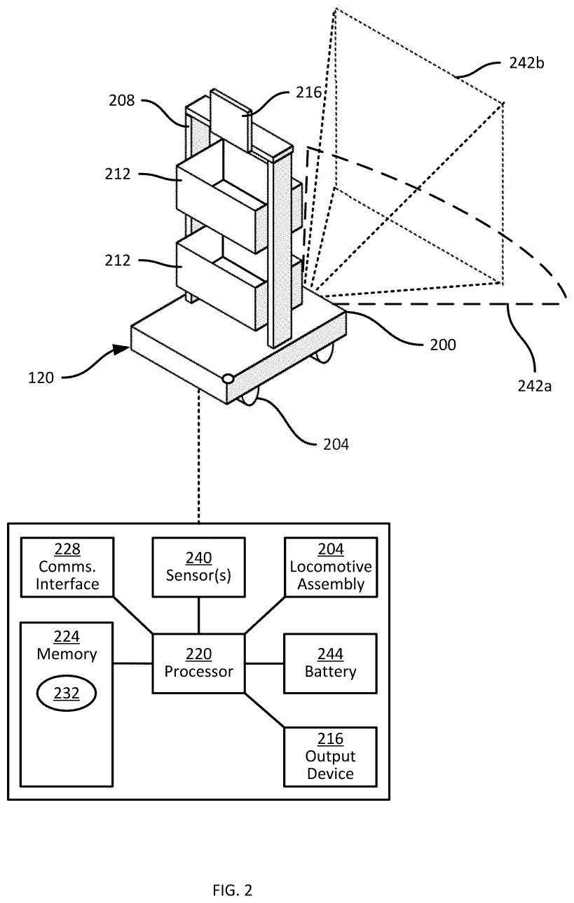

Before discussing the functionality implemented by the robot 120 in greater detail, certain components of the robot 120 are discussed with reference to FIG. 2. As shown in FIG. 2, the robot 120 includes a chassis 200 supporting various other components of the robot 120. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 120 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 120.

The robot 120 can also include an output device, such as a display 216. In the illustrated example, the display 216 is mounted above the rack 208, but it will be apparent that the display 216 can be disposed elsewhere on the robot 120 in other examples. The display 216 can include an integrated touch screen or other input device, in some examples, The robot 120 can also include other output devices in addition to or instead of the display 216. For example, the robot 120 can include one or more speakers, light emitters such as strips of light-emitting diodes (LEDs) along the rack 208, and the like.

The chassis 200 of the robot 120 also supports various other components, including a processor 220, e.g., one or more central processing units (CPUs), graphics processing units (GPUs), or dedicated hardware controllers such as application specific integrated circuits (ASICs). The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 120 to communicate with other computing devices, such as the server 128 and other robots 120.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224.

The chassis 200 can also support a sensor 240, such as one or more cameras and/or depth sensors (e.g., lidars, depth cameras, time-of-flight cameras, or the like) coupled with the processor 220. The sensor(s) 240 are configured to capture image and/or depth data depicting at least a portion of the physical environment of the robot 120. Data captured by the sensor(s) 240 can by used by the processor 220 for navigational purposes, e.g., path planning, obstacle avoidance, and the like, as well as for updating a map of the facility in some examples.

The sensors 240 have respective fields of view (FOVs). For example, a first FOV 242a corresponds to a laser scanner, such as a lidar sensor disposed on a forward-facing surface of the chassis 200. The FOV 242a can be substantially two-dimensional, e.g., extending forwards in a substantially horizontal plane. A second FOV 242b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 242.

The components of the robot 120 that consume electrical power can be supplied with such power from a battery 244, e.g., implemented as one or more rechargeable batteries housed in the chassis 200 and rechargeable via a charging port (not shown) or other suitable charging interface.

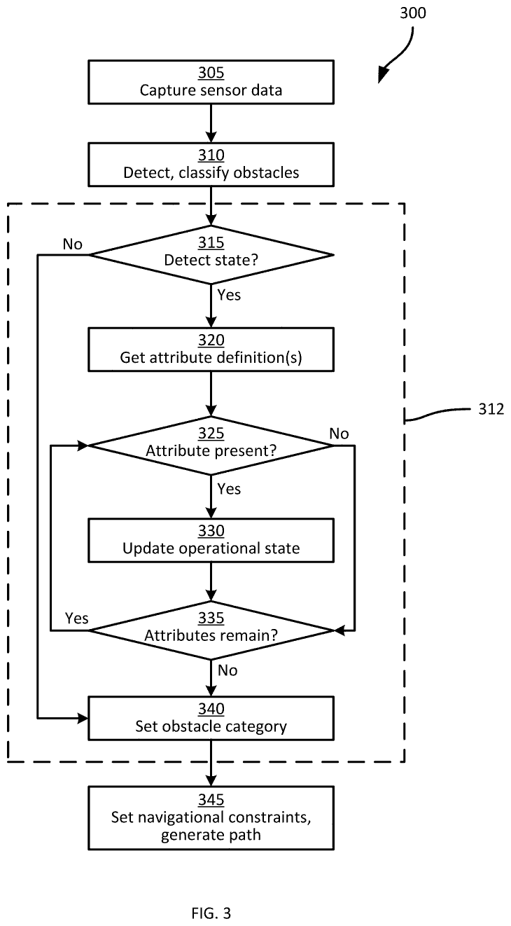

Turning to FIG. 3, a method 300 of operational state detection for obstacles is illustrated. The method 300 is described below in conjunction with its example performance in the facility 100. In particular, as indicated in FIG. 3, the blocks of the method 300 are performed by the mobile robot 120, e.g., via execution of the application 232 by the processor 220. In other examples, certain blocks of the method 300 can be performed by the server 128, e.g., to reduce computational load on the processor 220.

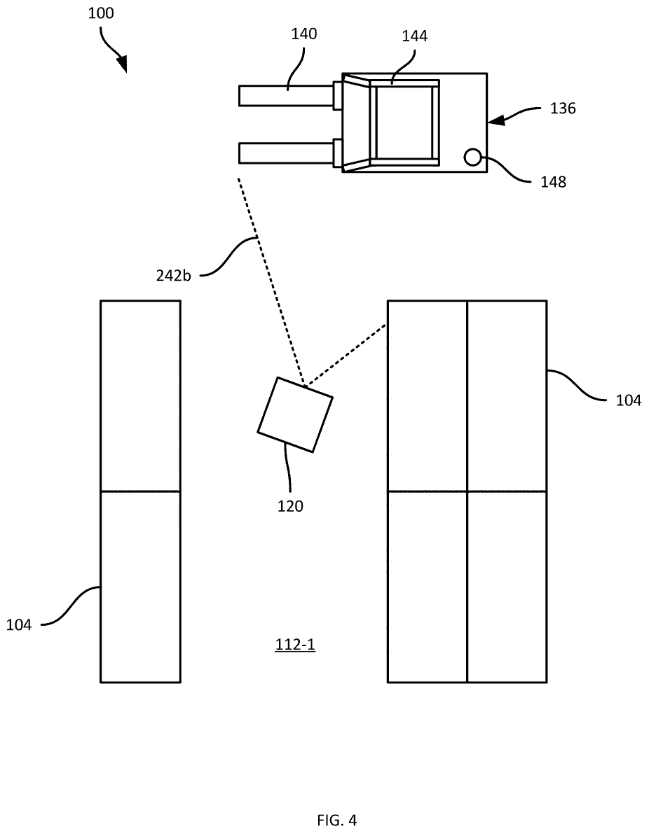

At block 305, the mobile robot 120 is configured to capture sensor data, e.g., by activating one or more of the sensors 240. For example, as shown in the overhead view of FIG. 4, the mobile robot 120 can activate one or more cameras defining the FOV 242b, to capture an image, or a sequence of images at a suitable frequency (e.g., 30 Hz) of a portion of the surroundings of the robot 120. In particular, the FOV 242b is directed forwards, in a direction the robot 120 is travelling. As seen in FIG. 4, the FOV 242b encompasses a portion of a support structure 104, as well as the forklift 136, which is outside the aisle 112-1 in which the robot 120 is currently located. The robot 120 can activate multiple sensors at block 305, including sensors of different types. As will be apparent, objects represented in the sensor data can be localized in the coordinate system 124 using a current pose of the robot 120 and the positions of the objects relative to the robot 120, as derived from the sensor data.

Referring to FIG. 3, at block 310, the robot 120 is configured to detect obstacles in the sensor data captured at block 305, and to classify the detected obstacles. Detecting and classifying obstacles includes detecting the locations of the obstacles in the coordinate system 124 from the sensor data and the robot's current pose, and also determining a type of each detected obstacle.

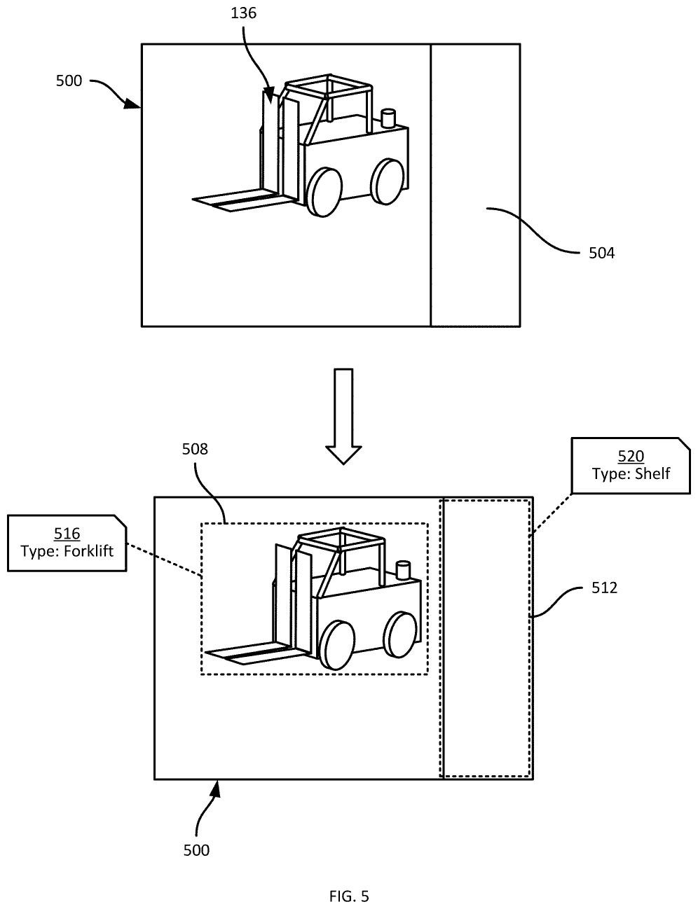

Turning to FIG. 5, an image 500 is shown as captured at block 305, e.g., with the robot 120 in the orientation shown in FIG. 4. Thus, a portion 504 of a support structure 104 and the forklift 136 are visible in the image 500. The processor 220 can perform various operations to detect and classify obstacles in the image 500. For example, the processor 220 can be configured to execute one or more classification models, such as a trained convolutional neural network (CNN) or the like, to obtain obstacle locations within the image 500 (e.g., in the form of bounding boxes) and obstacle types. Such a classifier can, for example, be configured to generate boundaries surrounding each obstacle, and to generate scores or other suitable confidence measures for each boundary. The scores generated for each boundary can indicate a likelihood that the boundary contains an obstacle of each of several obstacle types the classifier was trained to recognize. For example, a classifier configured to recognize forklifts, humans, and support structures, may generate three scores for each boundary, and select the highest score as the detected obstacle type.

As shown in the lower portion of FIG. 5, the processor 220 can therefore generate boundaries 508 and 512, surrounding the forklift 136 and the portion 504 of a support structure 104. The processor 220 can also detect (e.g., select from predetermined obstacle types for which the above-mentioned classifier was trained) obstacle types 516 and 520 for the contents of the boundaries 508 and 512, such as the obstacle type 516 “forklift” for the boundary 508, and the obstacle type “shelf” for the boundary 512. The processor 220 can also determine, from the sensor data captured at block 305, a velocity for a detected obstacle such as the forklift 136. In the example shown in FIGS. 4 and 5, the forklift 136 is stationary (i.e., has a velocity of zero).

Returning to FIG. 3, the processor 220 is then configured to perform a series of evaluations for each obstacle detected at block 310, contained within the boundary 312. That is, the blocks of the method 300 within the boundary 312 are repeated for each detected obstacle, and the method proceeds (to block 345, discussed further below) when no detected obstacles remain to be evaluated.

At block 315, the processor 220 is configured to determine whether to detect operational states for an obstacle detected and classified at block 310. Certain obstacles, such as the support structures 104, need not be evaluated to detect operational states. For example, support structures 104 may always be treated as static obstacles for navigational purposes (i.e., the navigational constraints applied to support structures 104 may be constant). As a further example, obstacles such as the worker 132 may always be treated as dynamic obstacles, and may therefore also not need operational state evaluation. As discussed below, the operational state of an obstacle can be used to determine which navigational constraints to apply when navigating in the vicinity of the obstacle. For example, when the robot 120 determines that the forklift 136 is in an operational state, the robot 120 may treat the forklift 136 as a dynamic (i.e., moving) obstacle even if the forklift 136 is currently stationary.

The determination at block 315 can be made according to whether the obstacle is currently in motion, and according to attribute definitions maintained by the robot 120, e.g., in the memory 224. Movement of obstacles can be detected from a sequence of images or other sensor data captured at block 305, and can be expressed as a vector in the coordinate system 124 (e.g., a location, an orientation, and a velocity). The detection of operational states for obstacles is used to determine whether to treat an obstacle as dynamic (i.e., in motion), even though that obstacle is currently stationary. In the case of the forklift 136, for example, detecting that the forklift 136 is operational (as opposed to idle) can lead to treating the forklift as a dynamic obstacle even when the forklift 136 is currently stationary. As a result, if the forklift 136 is in motion, operational state detection can be bypassed. More generally, the determination at block 315 for obstacles currently in motion is negative. For stationary obstacles, the determination at block 315 is further based on the above-mentioned attribute definitions.

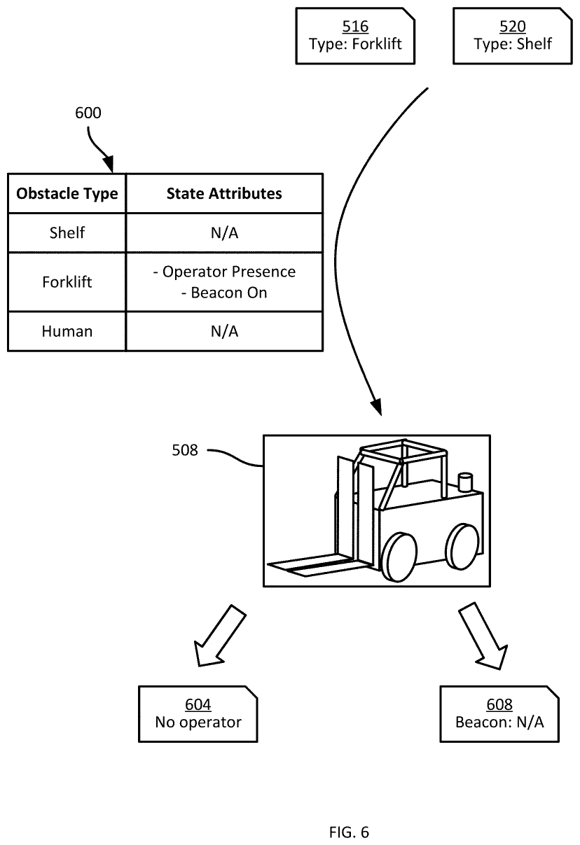

Turning to FIG. 6, a plurality of associations 600 between attribute definitions and obstacle types is illustrated. The obstacle types “Shelf” and “Human” do not have attributes associated with them, and the determination at block 315 for those obstacle types is therefore negative. The obstacle type “forklift”, however, is associated with the attributes “operator presence” and “beacon on”, and the determination at block 315 is therefore affirmative for the forklift 136 detected in the image 500. That is, any stationary forklifts detected in the sensor data from block 305 are subject to additional evaluation prior to selecting navigational constraints. The operational state of the forklift 136 as detected in the image 500 is initially an idle state (e.g., because the forklift 136 is stationary), but the operational state may be updated if the forklift 136 exhibits one or more of the attributes shown in FIG. 6.

Following an affirmative determination at block 315 for one or more obstacles detected at block 310, the processor 220 is configured to retrieve, e.g., from the memory 224, attribute definitions to be assessed for the relevant obstacles. Attribute definitions can specify processing operations to be performed on the sensor data corresponding to certain obstacles in order to determine whether those obstacles exhibit certain attributes. In this example, the processor 220 is configured to retrieve definitions for the “operator presence” and “beacon on” attributes shown in FIG. 6.

The attribute definition for operator presence may, for example, define a classification model configured to distinguish between forklifts with a human operator in the cab 144, and forklifts with an empty cab 144. The attribute definition for operator presence can also, in other examples, define a threshold distance between the forklift 136 and a human detected at block 310, such that a human detected closer to the forklift 136 than the threshold is considered an operator of the forklift 136. In other words, the attribute definition for operator presence can define one or more ways of determining whether a human is physically associated with the forklift 136.

The attribute definition for the beacon attribute can include criteria employed to determine whether the beacon 148 is illuminated. The criteria can include, for example, intensity and/or color thresholds to be evaluated against the portion of the image 500 within the boundary 508.

The processor 220 is then configured, at block 325, to determine whether a given attribute retrieved at block 320 is exhibited by the corresponding obstacle detected at block 310. In the example of FIG. 6, that is, at a first performance of block 325, the processor 220 is configured to determine whether an operator is present in the forklift 136, e.g., by providing the portion of the image 500 within the boundary 508 to the above-mentioned classifier. As seen in FIGS. 5 and 6, there is no operator in the forklift 136, and a result 604 of the evaluation at block 325 is therefore negative. The processor 220 is therefore configured to bypass block 330 (leaving an operational state of the forklift as non-operational) and determine whether any attributes remain to be evaluated at block 335.

In this example, the determination at block 335 is affirmative, because the beacon attribute remains to be evaluated. The processor 220 therefore returns to block 325 and determines whether the next attribute is exhibited by the relevant obstacle. The determination of whether the beacon 148 is illuminated produces a result 608, e.g., obtained by searching the boundary 508 for regions of higher intensity, regions having specific colors, or the like. The result 608, as shown in FIG. 6, indicates that no illuminated beacon was detected. The determination at block 325 is therefore negative. The determination at block 335 is negative in this instance, as no attributes from block 320 remain to be evaluated for the boundary 508. The processor 220 therefore proceeds to block 340. The operational state of the forklift 136 detected in the image 500, having not been updated via block 330, remains the idle state mentioned earlier.

At block 340, the processor 220 can be configured to set an obstacle category for the obstacle, either based on a combination of class and motion status from block 310, or from a combination of class, motion status, and operational state as evaluated via blocks 320 to 335. The obstacle category can be, for example, selected from a static category and a dynamic category. As noted earlier, the static category is generally applied to obstacles that are stationary, while the dynamic category is generally applied to obstacles that are in motion. The processor 220 may, however, apply the dynamic category to a stationary obstacle when the obstacle is in an operational state as opposed to an idle state (i.e., when the obstacle exhibits at least some portion of the attributes retrieved at block 320). In the present example performance of block 340, the processor 220 applies the static category to the forklift 136, as the operational state of the forklift 136 remains “idle”.

Setting an obstacle category can be implemented by storing a category label in association with the obstacle, for subsequent use in navigational processes, e.g., to select navigational constraints at block 345 when travelling in the vicinity of the obstacle. In other examples, block 340 can be omitted and navigational constraints can be selected based on a combination of obstacle class (from block 310) and operational state from blocks 320 to 335, as applicable.

Having processed the forklift 136 detected in the image 500, the processor 220 is configured to repeat the portion of the method 300 within the boundary 312 for the shelf portion 514 detected in the image 500. As discussed above, the determination at block 315 for the shelf portion 504 is negative, and at block 340, the processor 220 is configured to categorize the shelf portion 504 as a static obstacle.

At block 345, having processed and categorized each obstacle detected at block 310, the processor 220 is configured to set navigational constraints based on the detected obstacles, and generate a path to travel the facility 100, e.g., towards a target location assigned by the server 128.

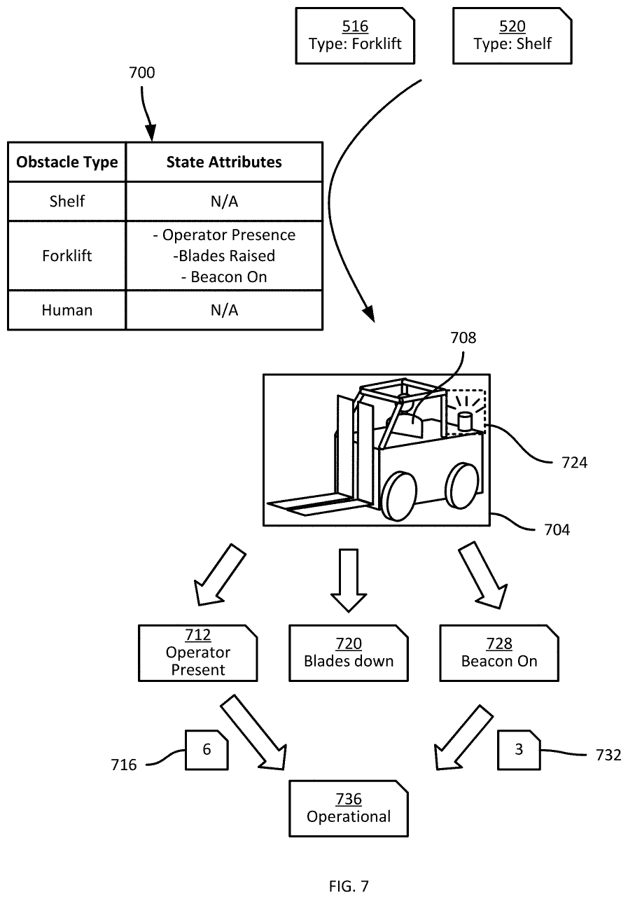

Before discussing the performance of block 345, a further example of operational state detection is shown in FIG. 7. In FIG. 7, the robot 120 stores attribute associations 700 that include an additional attribute association for the forklift obstacle type. In particular, the forklift obstacle type is associated with the two attributes discussed above, and also with a “blades raised” attribute. The “blades raised” attribute is exhibited by the forklift 136 when the blades 140 are at least a threshold distance above the ground (e.g., the floor of the facility 100). Assessment of whether the forklift 136 exhibits the “blades raised” attribute can include providing a portion 704 of an image captured at block 305 to a further classifier, e.g., trained to distinguish between forklifts with lowered blades 140 and forklifts with raised blades 140.

As also seen in FIG. 7, the image portion 704 shows that an operator 708 is in the cab 144 of the forklift 136. At block 325, having retrieved the three attributes mentioned above, the processor 220 can be configured to first determine whether the forklift 136 exhibits the “operator presence” attribute, e.g., by providing the image portion 704 to the classifier mentioned in connection with FIG. 5, yielding a result 712 indicating that an operator is present. That is, the forklift 136 is determined to exhibit the “operator presence” attribute. The processor 220 therefore proceeds to block 330 to update the operational state of the forklift 136.

Updating the operational state at block 330 can be implemented in various ways. For example, the operational state can be updated from “idle” to “operational” if any one of the attributes evaluated via block 325 is exhibited by the forklift 136. In other examples, updating the operational state at block 330 can include incrementing a score for each exhibited attribute. For example, each attribute can be associated with a score component, and the operational state can be updated from “idle” to “operational” when the aggregated score meets a threshold. In the example shown in FIG. 7, the operator presence attribute contributes a value 716 of six to such a score (it will be appreciated that a wide variety of scoring mechanisms and values can be employed). In this example, the threshold score for changing the operational state to “operational” is eight, and the operational state therefore remains “idle”.

Following a negative determination at block 335, the processor 220 can, at a next instance of block 325, whether the forklift exhibits the “blades raised” attribute. As noted above, the evaluation at block 325 can include providing the image portion 704 to a classifier configured to return a result 720 indicating whether the blades 140 are raised or lowered. In the example of FIG. 7, the result 720 indicates that the blades are lowered (i.e., the forklift 136 does not exhibit the “blades raised” attribute). No adjustment of the operational state score is therefore made.

The processor 220 can then, in a further performance of block 325, determine whether the forklift 136 exhibits the “beacon on” attribute. In the example of FIG. 7, the beacon 148 is illuminated, and the processor 220 therefore identifies a region 724 of increased intensity and/or having a predetermined color in the image portion 704. A result 728 of the determination at block 325 therefore indicates that the forklift 136 does exhibit the “beacon on” attribute. At block 330, therefore, the processor 220 can be configured to update the score with a predetermined value 732 associated with the “beacon on” attribute (e.g., three, in this example). The total score associated with the operational state (nine) therefore exceeds the above-mentioned threshold, and the operational state 736 is updated from “idle” to “operational” at block 330. At block 340, the forklift 136 is therefore categorized as a dynamic obstacle, despite currently being stationary.

At block 345, the processor 220 is configured to select navigational constraints and generate a path, e.g., towards a target location. The navigational constraints include constraints associated with the obstacles detected and classified at block 310. Navigational constraints can include, for example, a threshold distance from an obstacle to be maintained during navigation (that is, such that the robot 120 remains separated from the obstacle by at least the threshold distance). Navigational constraints can also include a maximum velocity to be employed by the robot 120 when in the vicinity of an obstacle.

The navigational constraints can be selected at block 345 from a table or other mapping of obstacle classes and operational states to constraints. For example, the memory 224 can store a first set of navigational constraints associated with the forklift class of obstacles, for use when a forklift 136 is in an idle state, and a second set of navigational constraints associated with the forklift class of obstacles, for use when a forklift 136 is in an operational state. In other examples, the navigational constraints can be stored in association with the categories discussed in connection with block 340, e.g., such that the first set of constraints is used for static obstacles and the second set of constraints is used for dynamic obstacles.

In some examples, a navigational constraint such as the separation distance mentioned above need not be stored explicitly. For example, the processor 220 can be configured to maintain an occupancy grid, lattice, or the like, representing the facility 100 (or a portion thereof). Navigational constraints can be implemented by assigning occupancy values (e.g., costs) to each cell of the occupancy grid or each edge connecting nodes in the lattice. The generation of a path at block 345 can be configured to travel to the target location while minimizing accumulated cost, and distance and/or velocity constraints can therefore be implemented by assigning higher or lower costs to the cells or edges the location of an obstacle.

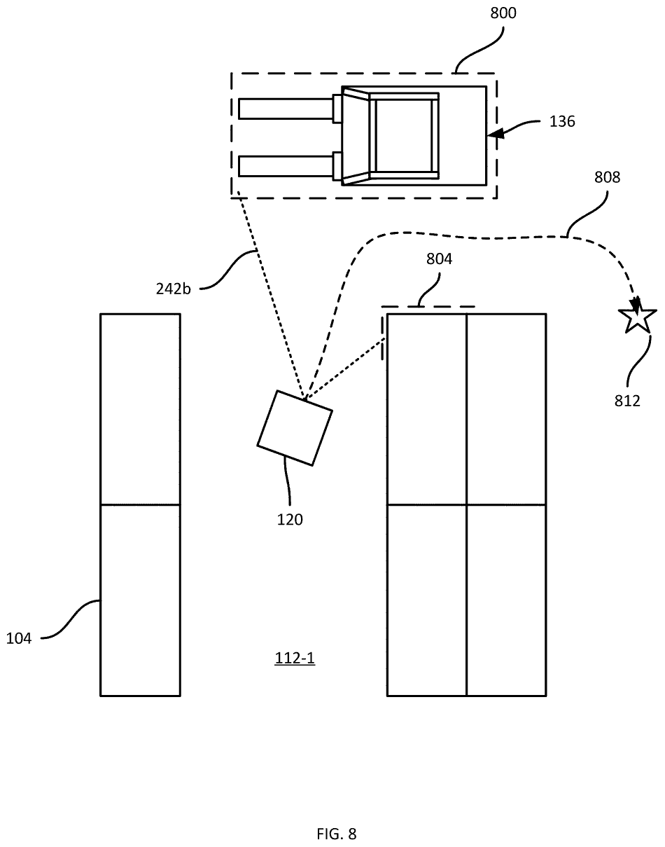

Turning to FIG. 8, an example performance of block 345 is illustrated, for a scenario in which the forklift 136 is in an idle state as discussed in connection with FIG. 6. As seen in FIG. 8, the navigational constraints selected include a separation distance represented by a boundary 800 surrounding the forklift 136, and a boundary 804 surrounding a portion of the support structure 104. As will be apparent, the boundaries 800 and 804 need not be explicitly stored (e.g., as sets of coordinates in the coordinate system 124) by the robot 120. Instead, the boundaries can be derived from occupancy costs, edge costs, or the like, assigned based on the categories assigned to the forklift 136 and support structure 104 at block 340.

The robot 120 can be configured to generate a path 808 to a target location 812 according to the navigational constraints (e.g., the boundaries 800 and 804). As seen in FIG. 8, there is sufficient unoccupied space between the boundaries 800 and 804 to permit passage of the robot 120.

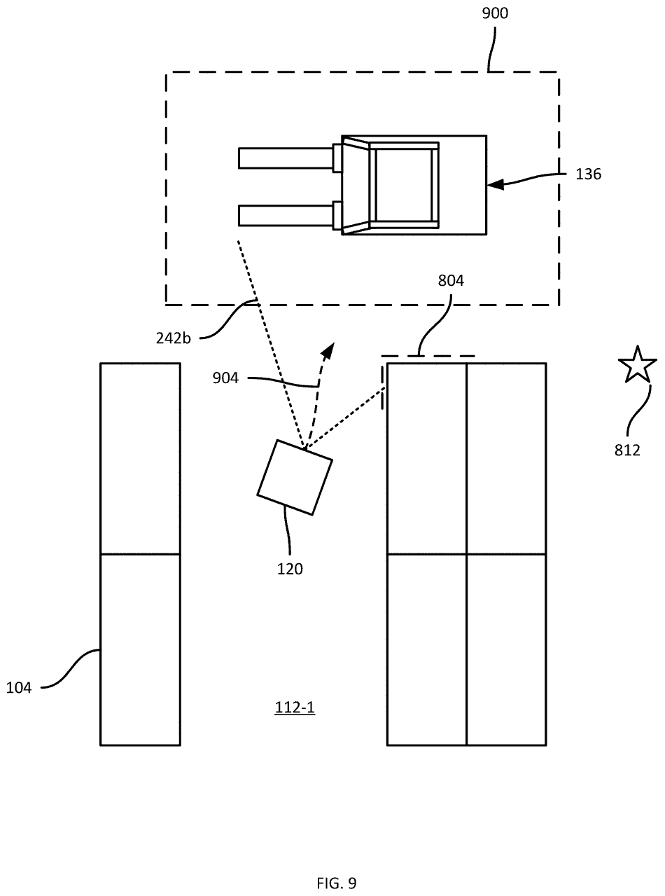

Turning to FIG. 9, another example performance of block 345 is illustrated, for a scenario in which the forklift 136 is in an operational state as discussed in connection with FIG. 7. In FIG. 9, a boundary 900 surrounding the forklift 136 implements a larger separation distance from the forklift 136, such that the robot 120 is prevented from planning a path that travels as close to the forklift 136 as in FIG. 8. As will be apparent, there is insufficient space between the boundaries 900 and 804 to permit passage of the robot 120. The robot 120 may, for example, plan a path 904 towards the end of the aisle 112-1 and then pause, e.g., to wait for the forklift 136 to move before planning a further path to the target location 812.

Various other attributes can be used to assess the operational state of the forklift 136, as well as other obstacles. A further example attribute includes the presence or absence of running lights distinct from the beacon 148. The assessment of operational states can also be extended to other obstacles in addition to or instead of the forklift. For example, the processor 220 can be configured to assess the operational state of a cherry picker, e.g., using some or all of the attributes noted above. Further example attributes that can be used to assess the operational state of a cherry picker include a determination of whether a boom of the cherry picker is raised (with a raised boom indicating an operational state rather than an idle state). In further examples, an operational state of another mobile robot 120 can be assessed via the method 300, e.g., by detecting the presence or absence of illuminated running lights.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing, using a sensor of a mobile robot, sensor data representing a physical environment of the mobile robot;
detecting, from the sensor data, an obstacle in the physical environment;
responsive to detecting the obstacle, determining from the sensor data whether the obstacle exhibits a predetermined attribute;
assigning an operational state to the obstacle, according to the determination;
selecting a navigational constraint based on the assigned operational state; and
controlling a locomotive assembly of the mobile robot to navigate the physical environment based on the selected navigational constraint.

2. The method of claim 1, wherein detecting the obstacle includes detecting a location of the obstacle, and a type of the obstacle selected from a plurality of obstacle types.

3. The method of claim 2, further comprising:
storing, in a memory of the mobile robot, an association between a definition of the predetermined attribute and the detected type of the obstacle.

4. The method of claim 3, further comprising:
prior to determining whether the obstacle exhibits the predetermined attribute, retrieving the definition of the predetermined attribute according to the detected type of the obstacle.

5. The method of claim 1, wherein assigning the operational state to the obstacle includes:
assigning a first operational state when the obstacle exhibits the predetermined attribute; and
assigning a second operational state when the obstacle does not exhibit the predetermined attribute.

6. The method of claim 1, further comprising:
determining from the sensor data whether the obstacle exhibits a further predetermined attribute;
wherein assigning the operational state to the obstacle is further according to the determination of whether the obstacle exhibits the further predetermined attribute.

7. The method of claim 1, wherein the navigational constraint includes a maximum travel velocity for the mobile robot.

8. The method of claim 1, wherein the navigational constraint defines a distance from the obstacle to be maintained during navigation of the physical environment.

9. The method of claim 1, wherein determining whether the obstacle exhibits the predetermined attribute includes determining whether a human is physically associated with the obstacle.

10. The method of claim 1, wherein determining whether the obstacle exhibits the predetermined attribute includes determining whether a movable component of the obstacle is in a predetermined position relative to the obstacle.

11. The method of claim 1, wherein determining whether the obstacle exhibits the predetermined attribute includes determining whether a light emitter of the obstacle is activated.

12. A computing device, comprising:
a sensor; and
a processor configured to:
capture, using the sensor, sensor data representing a physical environment of a mobile robot;
detect, from the sensor data, an obstacle in the physical environment;
responsive to detecting the obstacle, determine from the sensor data whether the obstacle exhibits a predetermined attribute;
assign an operational state to the obstacle, according to the determination;
select a navigational constraint based on the assigned operational state; and
control a locomotive assembly of the mobile robot to navigate the physical environment based on the selected navigational constraint.

13. The computing device of claim 12, wherein the processor is configured to detect the obstacle by detecting a location of the obstacle, and a type of the obstacle selected from a plurality of obstacle types.

14. The computing device of claim 13, further comprising:
a memory storing an association between a definition of the predetermined attribute and the detected type of the obstacle.

15. The computing device of claim 14, wherein the processor is further configured to:
prior to determining whether the obstacle exhibits the predetermined attribute, retrieve the definition of the predetermined attribute according to the detected type of the obstacle.

16. The computing device of claim 12, wherein the processor is further configured to assign the operational state to the obstacle by:
assigning a first operational state when the obstacle exhibits the predetermined attribute; and
assigning a second operational state when the obstacle does not exhibit the predetermined attribute.

17. The computing device of claim 12, wherein the processor is further configured to:
determine from the sensor data whether the obstacle exhibits a further predetermined attribute; and
assign the operational state to the obstacle according to the determination of whether the obstacle exhibits the further predetermined attribute.

18. The computing device of claim 12, wherein the navigational constraint includes a maximum travel velocity for the mobile robot.

19. The computing device of claim 12, wherein the navigational constraint defines a distance from the obstacle to be maintained during navigation of the physical environment.

20. The computing device of claim 12, wherein the processor is further configured to determine whether the obstacle exhibits the predetermined attribute by determining whether a human is physically associated with the obstacle.

21. The computing device of claim 12, wherein the processor is further configured to determine whether the obstacle exhibits the predetermined attribute by determining whether a movable component of the obstacle is in a predetermined position relative to the obstacle.

22. The computing device of claim 12, wherein the processor is further configured to determine whether the obstacle exhibits the predetermined attribute by determining whether a light emitter of the obstacle is activated.
